(19) United States
(12) Patent Application Publication
(10) Pub. No.: US 2026/0094389 A1
(43) Pub. Date: Apr. 2, 2026

(54) SYSTEMS AND METHODS FOR SELECTIVELY DISPLAYING OVERLAYS IN AN AUGMENTED REALITY ENVIRONMENT

(71) Applicant: Adeia Guides Inc., San Jose, CA (US)

(72) Inventors: Dhananjay Lal, Englewood, CO (US); Ning Xu, Irvine, CA (US)

(21) Appl. No.: 18/902,385

(22) Filed: Sep. 30, 2024

(51) Int. Cl. G06T 19/00; G06F 3/01; G06V 20/20

(52) U.S. Cl. CPC G06T 19/006; G06V 20/20; G06F 3/013

(57) ABSTRACT

Systems and methods are provided for selectively displaying overlays in an augmented reality environment. A scene is monitored by an augmented reality head-mounted display to identify digitized objects. Candidate overlays associated with each digitized object are identified for potential display in the augmented reality environment. A plurality of relevancy values may be determined for each digitized object, along with a weight factor for each relevancy value. A combined metric is calculated for each digitized object based on the relevancy values and the associated weight factors, and a metric ranking of the digitized objects is generated based on the calculated combined metrics. Using the metric ranking, one or more of the candidate overlays are selected for display on an overlay display of the augmented reality head-mounted display, and the selected candidate overlays are displayed on the overlay display.

### BACKGROUND

This disclosure is related to providing content, and more particularly to systems and methods for displaying overlay content in an augmented reality environment.

### SUMMARY

With ever increasing computational power, whether embedded on a device or network accessible, augmented reality (AR) head-mounted displays (HMDs) (e.g., AR glasses, AR goggles, and the like) are becoming more capable of displaying rich user interfaces with large amounts of information overlayed on real-world scenes. There is, however, a limit to a field of view and, accordingly, a limit to the available area to display AR images within a field of view. A human might have a 180-degree field of view and HMDs typically feature far less. With a limited amount of display area available, adding significant amounts of information to the HMD overlay display may overwhelm, distract, cause confusion, and/or cause safety issues. For example, highly capable AR glasses may create significant visual complexity with an overlay display crowded with information. Other downsides for too much information on an overlay display may cover too much of the view, block other overlays with valuable information, and/or distract in a potentially dangerous manner. The information displayed on an overlay display in AR should be manageable and encourage wear, use, and benefit from the displayed information of an AR HMD.

A problem that may frequently arise with displaying information overlays in AR is information overload. Information overload may often occur when there are too many AR overlays within a field of view of an HMD. For example, the problem of information overload may be particularly acute in cities and other similar environments. In a city, information overlays may be displayed relating to weather, directions, cars, road signs, public transportation, nearby businesses, and interesting landmarks, among many other things that are present in a city. In addition, an AR HMD may still have information overlays relating to email, texts, social media accounts, and the like. If there are too many overlays in a limited display space, information of higher importance will be lost. With all the potential information that could be displayed in information overlays, the problem becomes which information overlays should be selected for display on the AR HMD. Typically, the most important information overlays are indicated in a user profile as explicitly relevant to them and therefore should be prioritized for display. Such explicitly relevant information overlays may include, e.g., email, text messages, messages on other messaging or social media platforms, directions to a location, notifications from active applications, personal information, and other information expressly requested alerts and overlays.

With the display of explicitly relevant information in overlays, space may still exist on the overlay display to display implicitly relevant information. Implicitly relevant information may be considered any information serendipitously discoverable from a current environment. Many AR applications augment a view of a surrounding environment with unexpected and unanticipated data and information types. Approaches that eliminate overlays with implicitly relevant information in favor of only using overlays with explicitly relevant information are essentially eliminating an AR function. In many cases, new discoveries in a surrounding environment through display of serendipitously discoverable information may be considered an essential function of AR. For example, a history buff may always be interested in learning historical facts about a landmark they encounter or pass nearby. Similarly, a plant enthusiast may always be interested in learning about the plants growing in the gardens and planters they pass by. In a busy city, a car enthusiast may be interested in classic cars that are nearby. A fashion enthusiast may be interested in the fashions worn by others walking on the streets in a city. A trivia buff may be interested in learning random trivia about the city environment they are in. In almost any environment, the AR HMD may discover and display serendipitously discoverable information that is implicitly relevant to interests, e.g., stored in a profile. However, the problem of controlling the display of implicitly relevant information in overlays on a limited field of view without exposing the AR HMD wearer to information overload still exists. Providing overlays with implicitly relevant information along with overlays with explicitly relevant information can quickly fill up a display area.

A need therefore exists to organize and optimize the display of information overlays in an AR HMD to avoid information overload on the display interface. To address this need and overcome the shortcomings introduced by existing systems that tend to display too much information to the wearer of an AR HMD, systems and methods that selectively display information overlays are presented. In such systems and methods, an improved AR user interface is used to selectively control overlay presentation.

In some embodiments, candidate overlays may be identified based on digitized objects generated from images of the scene in the surrounding environment. A combined metric is calculated for each digitized object so that the candidate overlays associated with the digitized objects may be ranked and selected for display based on the combined metric. The combined metric may be calculated from relevancy values determined for each digitized object and weight factors determined for each relevancy value. The relevancy values and associated weights serve as numerical determinations for use in evaluating the implicit relevance of each digitized object, e.g., for a user profile.

In some embodiments, the relevancy values may be based on different determinations, such as previously expressed interests of the profile, current implicit interests of the profile, the HMD location, the time of day, among other determinations. One or more of the relevancy values and/or weight factors may be assigned based on present or existing information related to the user profile. One or more of the relevancy values may be calculated based on information provided via the AR interface and/or based on real-time conditions. The relevancy values and/or the weight factors may be determined differently for different users, or differently for a single user based on real-time circumstances. Through such systems and methods, the AR HMD may display information overlays with serendipitously discoverable information that might not be otherwise discovered.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. The figures include:

FIG. 1 schematically illustrates an exemplary software framework for selecting overlays for display in an augmented reality environment, in accordance with embodiments of the disclosure;

FIG. 2 illustrates an exemplary head-mounted display for selectively displaying overlays in an augmented reality environment, in accordance with some embodiments of this disclosure;

FIG. 3 is a flowchart showing an exemplary process for selectively displaying overlays in an augmented reality environment, in accordance with embodiments of the disclosure;

FIG. 4 graphically illustrates using actual and hypothetical gaze vectors for use in determining a likelihood of viewing value, in accordance with embodiments of the disclosure;

FIG. 5 schematically illustrates an exemplary system architecture for selectively displaying overlays in an augmented reality environment, in accordance with embodiments of the disclosure; and

FIG. 6 is an example of an illustrative system implementing equipment, in accordance with embodiments of the disclosure.

### DETAILED DESCRIPTION

Systems and methods are described herein for selectively displaying overlays in an augmented reality environment. The systems and methods may be used to improve the selection and display of overlays to the wearer of an augmented reality (AR) head-mounted display (HMD) and to help avoid exposing the wearer to information overload while also displaying contextually desirable information to the wearer. Advantageously, the systems and methods may be used to display to the AR HMD wearer overlays with serendipitously discoverable information that the wearer might have not otherwise discovered.

As referred to herein, the term “content” should be understood to mean an electronically consumable asset accessed for purposes of selectively displaying one or more overlay displays in an AR environment. The content may originate from one or more sources, such as broadcast television, pay-per-view, on-demand (as in video-on-demand (VOD) systems), network-accessible media (e.g., streaming media, downloadable media, Webcasts, etc.), video clips, information about media, images, animations, documents, playlists, websites and webpages, articles, books, electronic books, blogs, chat sessions, social media, software applications, games, virtual reality media, augmented reality media, and/or any other media or multimedia source and/or any combination thereof. In addition, the content may be static content displayed to the AR HMD wearer, or it may be interactive content that the AR HMD wearer may manipulate through interacting with the overlay displaying the interactive content.

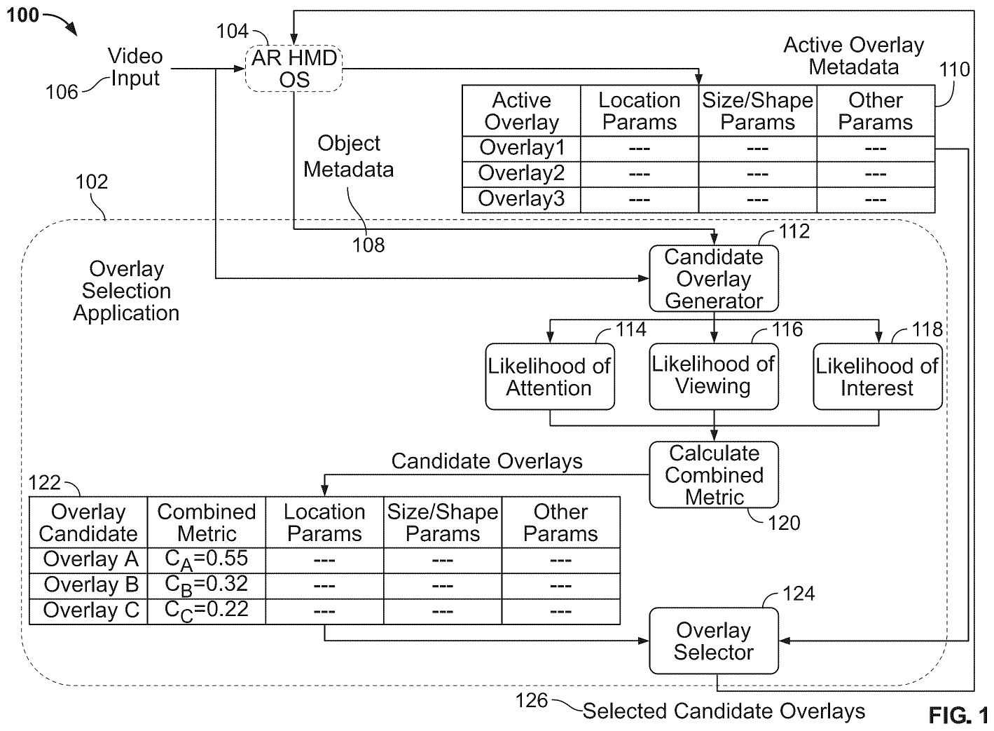

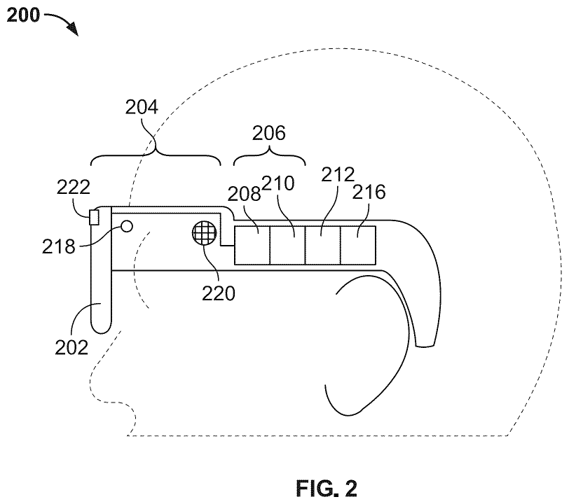

Turning in detail to the drawings, FIG. 1 shows software architecture 100 in which an overlay selection application 102 interacts with the AR HMD operating system (OS) 104 to select and generate candidate overlays for display on the overlay display integrated as part of the AR HMD. Both the overlay selection application 102 and the AR HMD OS 104 are integrated with and functionally executed by the AR HMD. In some embodiments, the AR HMD may be AR glasses. In some embodiments, the AR HMD may be AR goggles. The form factor of the AR HMD is intended to be non-limiting. For purposes of clarity, unless otherwise indicated, all processes, functions, software, systems, and the like discussed herein, including the software architecture 100, are described in the context of being implemented on the AR HMD 200 shown in FIG. 2.

Communications between components of the software architecture 100 may be achieved using any functional programmatic technique or accessible hardware connection. For example, communications between components may be achieved by a first component writing data to a memory space that may be accessed and read by a second component. As another example, communications between components may be achieved by the AR HMD OS 104 acting as an intermediary to pass data from a first component to a second component. In yet another example, a first component and a second component may be configured to communicate directly with each other. In embodiments in which components of the software architecture 100 reside on and/or are executed in different physical spaces (e.g., by distinct hardware components), communications between components may be achieved via one or more hardware connections (e.g., traces, wired connections, wireless communications connections, and the like).

A video input 106 is generated by an image sensor and communicated to the overlay selection application 102 and to the AR HMD OS 104. The video input 106 is of a scene that is within the field of view of the image sensor (and therefore also within the field of view of the wearer of the AR HMD), and the image sensor is integrated as part of the AR HMD. In some embodiments, the image sensor may include a digital video camera operating within the visible spectrum of light. In some embodiments, the image sensor may include a digital video camera operating in multiple light spectrums. The AR HMD OS 104 analyzes the video input 106 to identify digitized objects representing portions of the scene. In some embodiments, the AR HMD OS 104 may perform this analysis by capturing an image frame from the video input 106 and performing image analysis on the captured image frame to identify digitized objects represented in the captured image frame. In some embodiments, the AR HMD OS 104 may perform the analysis on video itself without capturing an image frame. For purposes of clarity, the description below is discussed in terms of the AR HMD OS 104 analyzing the video input 106 by capturing an image frame from the video input 106. However, it should be recognized that the video input 106 analysis process is not intended to be so limited.

In some embodiments, the image analysis may be performed using image segmentation and object detection techniques, which is a computer vision processing technique that partitions a captured image into discrete groups of pixels, referred to as image segments, and those image segments may be used to inform detection of digitized objects. In some embodiments, the image segmentation may be performed using techniques such as threshold-based image segmentation, edge-based image segmentation, region-based image segmentation, clustering-based image segmentation, and/or artificial neural network-based segmentation, among others. Through implementation of such techniques, the AR HMD OS 104 may be enabled to identify digitized objects for purposes of identifying candidate overlays as discussed herein.

Each digitized object is represented by groups of pixels, and each digitized object is associated with object metadata 108, which is generated by the AR HMD OS 104 during the image analysis process. In some embodiments, each digitized object may be represented by groups of voxels, or in some embodiments groups of pixels and/or groups of voxels. In embodiments that use voxels, a group of voxels may represent a digitized object having volumetric depth within a three-dimensional image that is generated based on the scene within the field of view of the AR HMD. In such embodiments, the AR HMD may be equipped with image sensors and/or enable the AR HMD OS 104 3D image reconstruction processes that enable a three-dimensional image to be generated in real-time. For purposes of clarity, digitized objects are discussed herein as being represented by groups of pixels, and this form of the digitized objects is intended to be non-limiting. While each digitized object is represented by groups of pixels, each digitized object may represent anything physically present in the scene within the field of view of the image sensor. For example, in a scene of a city street, a digitized object may represent a street sign, a car that is parked or driving on the street, a business sign, a place of business, a bus stop, a tree, a shrub, flowers, a landmark, and anything else within the field of view of the image sensor. As part of the image analysis, in addition to analyzing the captured image frame, the AR HMD OS 104 may monitor the video input 106 to facilitate identifying digitized objects represented in the scene, as the motion of video may aid in identifying groups of pixels that form a digitized object.

The object metadata 108 may include any data the AR HMD OS 104 is able to generate about an associated digitized object. In some embodiments, the object metadata 108 may include data derived directly from analysis of the video input 106. In such embodiments, the object metadata 108 may include detailed information derived from the video (e.g., frame rate, time of day, location, etc.), the captured image, and/or the pixels (e.g., color, brightness, focus, etc.). In some embodiments, the AR HMD OS 104 may perform object detection on the captured image to determine the type of real-world object in the scene represented by a digitized object. In such embodiments, the AR HMD OS 104 may utilize local and/or network resources to perform the object detection and/or gather additional data related to the digitized object. For example, the contextual circumstances associated with the scene may aid in the object detection process (e.g., location, time of day, other more readily identifiable digitized objects associated with the scene, and the like). Any additional data gathered and/or generated by the AR HMD OS 104, if related to the digitized object, may be incorporated into the object metadata 108.

In some embodiments, the video input 106 may be generated with multiple frames per second (e.g., 8 fps, 16 fps, 24 fps, 30 fps, or other frame rates), and the AR HMD OS 104 may capture for analysis fewer than all the frames generated in the video per second. For example, the AR HMD OS 104 may capture one frame per second for analysis, or the AR HMD OS 104 may capture multiple frames per second for analysis. In some embodiments, the AR HMD OS 104 may capture fewer than one frame per second, e.g., one frame every two seconds or more, for analysis.

In addition to analyzing the video input to generate object metadata 108, the AR HMD OS 104 also maintains information relating to active overlays (active overlays are overlays that may be displayed but are not selected for display by the overlay selection application 102, and active overlays may be given priority for display based on prior explicit relevance indicated by the AR HMD wearer) and controls the display of all overlays on the overlay display. The information relating to active overlays may include display parameters and active overlay metadata 110. The display parameters for each active overlay provide the AR HMD OS 104 with detailed information related to displaying each active overlay on the overlay display. The display parameters for each active overlay may include text and graphics to be displayed as part of each active overlay, font type and font size, and a color palette. The display parameters may also include additional data for use by the AR HMD OS 104 to display each active overlay on the overlay display. The active overlay metadata 110 may include additional information related to each active overlay, including, for example, an overlay identifier, an application identifier to identify an active user application that may have generated the respective active overlay, the preferred display location for the active overlay on the overlay display, the preferred display size for the active overlay, and other data associated with the display of the active overlay. The AR HMD OS 104 may use the display parameters and the active overlay metadata 110 associated with a respective active overlay to generate the active overlay for display on the overlay display. The AR HMD OS 104 may make additions and/or changes to the active overlay metadata 110 associated with an active overlay based on the generation and display of the active overlay. For example, in some embodiments, the display location of an active overlay on the overlay display and/or the display size of an active overlay may be added to the active overlay metadata 110.

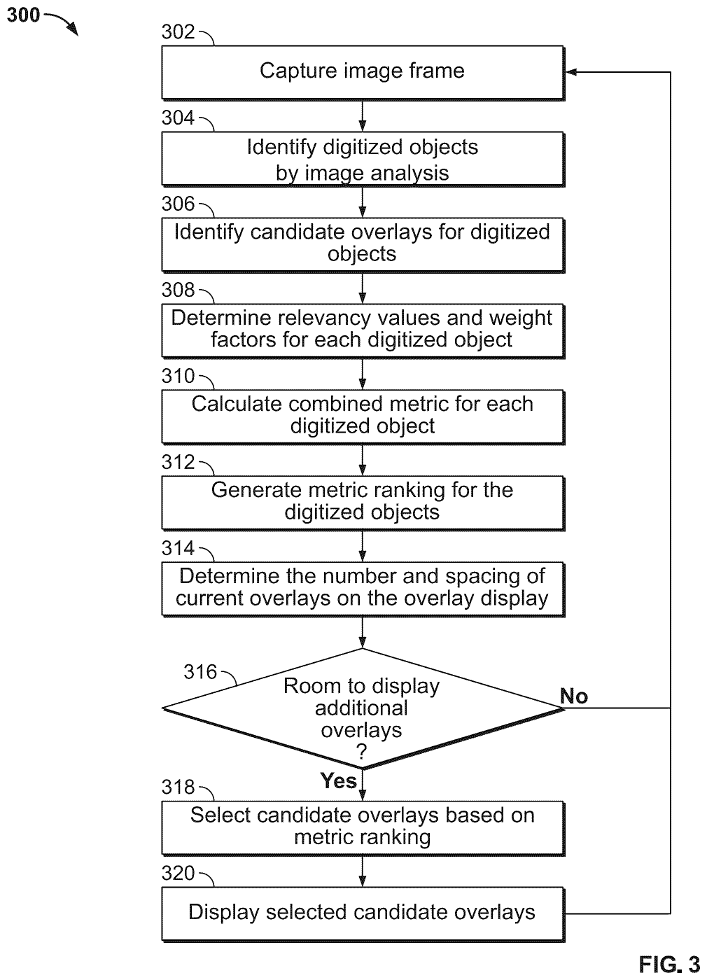

The AR HMD OS 104 communicates the object metadata 108 to the overlay selection application 102 for analysis by the candidate overlay generator 112. In some embodiments, the overlay selection application 102 may perform the image analysis process instead of the AR HMD OS 104. In such embodiments, this may alleviate any synchronization issues between the AR HMD OS 104 and the overlay selection application 102 when each component performs different parts of the overlay selection process (see FIG. 3) based on the same video input 106. In some embodiments, the overlay selection application 102 may be entirely incorporated into the AR HMD OS 104, which would also alleviate any synchronization issues. In such embodiments, the AR HMD OS 104 may perform the entire overlay selection and display process without the wearer actively invoking the overlay selection application 102 as a separate application.

The candidate overlay generator 112 generates candidate overlays based on the information included in the object metadata 108. In addition, the candidate overlay generator 112 may also add information to the object metadata 108 as such information is gathered as part of generating a candidate overlay. For example, the candidate overlay generator 112 may use the object metadata 108 and the video input 106 to identify the object in the scene that is represented by the digitized object and retrieve additional information related to the identified object. The additional information may be retrieved from associated personal devices of the wearer and/or from network accessible resources. Information relating to the generated candidate overlays may also be added to each respective object metadata 108. As part of processing the object metadata 108, the candidate overlay generator 112 generates the candidate overlay metadata 122, which may include all data from the object metadata 108 plus any additional information included by the candidate overlay generator 112 during processing. The information relating to the candidate overlay may include the preferred display location for the candidate overlay on the overlay display, the preferred display size and/or shape parameters for the candidate overlay, and other data associated with the display of the candidate overlay on the overlay display.

As indicated, the object metadata 108 may include any information relating to the digitized object. Each digitized object is a collection of pixels, such that the object metadata 108 may include information about the pixels, including information such as the optical focus of the digitized object (which may aid in identifying digitized objects beyond the depth of field of the image sensor), the number of pixels, the configuration or shape of the pixels, the color distribution of the pixels, the range of brightness values for the pixels, and the like. The object metadata 108 may also include object recognition information associated with the digitized object, such as object identification information, geolocation information, time of day information, position within the video, location of network-accessible information, and the like. For example, the object metadata 108 may include text on a street sign, more information about the subject of a sign, the make and model of a car, the website address of a business, a bus schedule, the proper name and other information about a plant, sources of information about a landmark, and other types of related extra information related to the real-world subject of a digitized object. The candidate overlay generator may collect such extra information relating to a digitized object as the candidate overlay is identified and generated for potential display to the wearer on the overlay display. The candidate overlay metadata 122 may therefore include all this same information from the related object metadata 108.

In some embodiments, the software architecture 100, whether through the overlay selection application 102 and/or the AR HMD OS 104, may exclude from further processing predetermined types of digitized objects following the object detection process. For example, the software architecture 100 may exclude people's faces from any further processing once a group of pixels is identified as a face. In another example, the software architecture 100 may exclude vehicle license plates from any further processing once a group of pixels is identified as a license plate. Other categories of digitized objects may also be excluded from further processing once initially identified.

In some embodiments, another active application may reserve certain categories of digitized objects, based on associated topics of interest, from being processed. This may occur when an active application is displaying an active overlay related to the topic of interest associated with the digitized object. For example, if the AR HMD wearer is walking on the streets in a city looking for a place to eat and already has a map application displaying information about restaurants nearby, the software architecture 100 may exclude the selection of candidate overlays relating to the topics of restaurants and food.

Once the candidate overlay generator 112 identifies and generates candidate overlays, then the associated digitized objects are assessed for relevancy. The relevancy assessment for each digitized object is made by determining a plurality of relevancy values and associated weight factors and then calculating a combined metric using those relevancy values and weight factors. As shown, three relevancy values and associated weight factors are determined: the likelihood of attention 114 and the attention weight factor, the likelihood of viewing 116 and the viewing weight factor, and the likelihood of interest 118 and the interest weight factor. In some embodiments, additional or fewer relevancy values may be determined for each digitized object. In some embodiments, each weight factor is a number in the range of 0 to 1. The weight factors are used to exponentially weight the associated relevancy value. In some embodiments, each relevancy value is either assigned or calculated as a number in the range of 0 to 1. Other numerical ranges may be used for the relevancy values and/or the weight factors.

Details for determining and/or calculating each of the relevancy values are included below in the discussion relating to FIG. 3. As an overview, the likelihood of attention relevancy value may be a measure of the visual salience of a digitized object, and that measure is based on a determination that the digitized object is sufficiently different from other parts of the scene, as represented in the captured image, to be worthy of attention. This measure of salience does not provide an understanding of what the digitized object represents in the real-world, but rather only that the digitized object stands out within the captured image of the scene. The likelihood of viewing relevancy value may be based on a determination of how likely the wearer is to view the digitized object based on the current head pose and gaze with respect to the location of the digitized object. The likelihood of interest relevancy value may be based on how likely the AR HMD wearer to be interested in the digitized object in view of prior configuration information provided by the wearer and/or by the AR HMD learning the wearer's preferences over time from gaze data and the wearer's interactions with applications and/or other real-world objects. The likelihood of interest relevancy value therefore represents the wearer's interest in a digitized object (or at least interest in the real-world subject represented by the digitized object) following semantic interpretation of the real-world object that the digitized object represents.

Once the relevancy values are determined, the overlay selection application 102 calculates the combined metric 120 for each digitized object. Details for calculating the combined metric are included below in the discussion relating to FIG. 3. As an overview, the combined metric may be calculated for each digitized object by weighting each relevancy value using the associated weighting factor as an exponent and multiplying the weighted relevancy values together. Because each of the relevancy values and the weight factors are selected and/or calculated as a number between 0 to 1, this manner of calculating the combined metric will also result in a number that is between 0 to 1. The calculated combined metric for each digitized object may then be added to the associated candidate overlay metadata 122.

Following calculation of the combined metric for each digitized object, the overlay selector 124 generates a metric ranking from the combined metric of all digitized objects. In some embodiments, the metric ranking may place the combined metrics in order of greatest value to least value so that the candidate overlays for the highest ranked digitized objects may be selected for display on the overlay display by the overlay selector 124. In some embodiments, the overlay selector 124 may be provided with information relating to actively displayed overlays so that when selecting candidate overlays for display, overcrowding the overlay display with too many overlays may be avoided. For example, the candidate overlay metadata 122 lists the top three candidate overlays based on the metric ranking for the associated digitized objects. However, should room exist for only two candidate overlays on the overlay display, the overlay selector may select only the top two candidate overlays for display. Other factors, such as those discussed below, may be considered by the overlay selector 124 when selecting candidate overlays for display. In some embodiments, the overlay display may not have sufficient space to display one of the top ranked candidate overlays (e.g., a candidate overlay would take up too much display space when displayed along the already active overlays). In such embodiments, the overlay selector 124 may skip the candidate overlay that would occupy too much space and select the next highest ranked candidate overlay for display. After the candidate overlays are selected for display, the overlay selection application 102 communicates the selected candidate overlays 126 to the AR HMD OS 104 to be displayed.

FIG. 2 shows an illustrative head-mounted display (HMD) 200, in the form of AR glasses, for enabling a user to view overlays within an AR environment. The AR HMD 200 includes components in accordance with some embodiments of this disclosure, such that the AR HMD 200 shown is intended to be non-limiting. The AR HMD 200 includes a display 202 enclosed within a mask 204, control circuitry 206, storage 210, input/output (I/O) circuitry 212, and a power source 216. The control circuitry 206 may include a processor 208. The AR HMD 200 may also include one or more integrated components such as a microphone 218, a speaker 220, and/or a camera 222. The AR HMD 200 may also include an input interface for communicably coupling external devices (e.g., game controllers, AR controllers, keyboards, remotes, touch-sensitive input devices, speakers, etc.) to the AR HMD 200.

The AR HMD 200 may access, transmit, receive, and/or retrieve content and data, including content media for use in displaying overlays, via the I/O circuitry 212 communicably coupled to the control circuitry 206. As an illustrative example, the I/O circuitry 212 may provide the control circuitry 206 with access to content (e.g., broadcast programming, on-demand programming, internet content, content available over a local area network (LAN) or wide area network (WAN), and/or other content) and data. The control circuitry 206 may be used to send and receive commands, requests, and other data using the I/O circuitry 212. The I/O circuitry 212 may communicatively couple the control circuitry 206 to other user devices, networks, servers, and the like.

The overlay display 202 is depicted as a generalized embodiment of a head-mounted display for viewing an AR environment. The display 202 may include an optical system of one or more optical elements such as a lens in front of an eye of the viewer, one or more waveguides, or an electro-sensitive plane. The display 202 includes an image source providing light output as an image to the optical element. Some non-limiting examples of a display include a tensor display, a light field display, a volumetric display, a multi-layer display, an LCD display, amorphous silicon display, low-temperature polysilicon display, electronic ink display, electrophoretic display, active matrix display, electro-wetting display, electro-fluidic display, cathode ray tube display, light-emitting diode display, organic light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying AR overlays and other AR content.

The control circuitry 206 may be based on any suitable control circuitry. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. A processor 208 may include video processing circuitry (e.g., integrated and/or a discrete graphics processor). In some embodiments, the control circuitry 206 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 206 executes instructions stored in memory (e.g., the storage 210). Specifically, the control circuitry 206 may be instructed to perform any of the functions described herein.

The control circuitry 206 may include or be communicatively coupled to video generating circuitry and tuning circuitry, such as one or more analog tuners, one or more H.265 decoders or any other suitable digital decoding circuitry, high-definition tuners, or any other suitable tuning or video circuits or combinations of such circuits. Conversion circuitry (e.g., for converting over-the-air, analog, or digital signals to MPEG signals for storage) may also be provided. The control circuitry 206 may also include scaler circuitry for upconverting and downconverting content into a suitable output format for the AR HMD 200. The control circuitry 206 may also include or be communicatively coupled to digital-to-analog converter circuitry and analog-to-digital converter circuitry for converting between digital and analog signals. The tuning and generating circuitry may be used by the AR HMD 200 to receive and to display, to play, and/or to record content. The tuning and generating circuitry may also be used to receive video generating data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If the storage 210 is provided or supplemented by a separate device from the AR HMD 200, the tuning and generating circuitry (including multiple tuners) may be associated with the storage 210.

The storage 210 may be any device for storing electronic data, such as random-access memory, solid state devices, quantum storage devices, hard disk drives, non-volatile memory or any other suitable fixed or removable storage devices, and/or any combination of the same. The storage 210 may be an electronic storage device that is part of the control circuitry 206. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. The storage 210 may store data defining images for display by the AR HMD 200. The storage 210 may be used to store various types of content described herein including AR asset data. Nonvolatile memory may also be used (e.g., to launch a boot-up routine and other instructions). Cloud-based storage may be used to supplement the storage 210 or instead of the storage 210.

The control circuitry 206 may include or be coupled to the I/O circuitry 212, which is suitable for communicating with servers, edge computing systems and devices, table or database servers, or other networks or servers. The instructions for carrying out the above-mentioned functionality may be stored on a server. Such communications may involve the internet or any other suitable communication networks. In addition, the I/O circuitry 212 may include circuitry that enables peer-to-peer communication of user devices, or communication of user devices in locations remote from each other. In some embodiments, the I/O circuitry 212 may include circuitry that communicatively couples the AR HMD 200 to one or more other devices over a network. For example, the I/O circuitry 212 may include a network adaptor and associated circuitry. The I/O circuitry 212 may include wires and/or busses for connecting to a physical network port (e.g., an ethernet port, a wireless WiFi port, cellular communication port, or any other type of suitable physical port). Although communication paths are not shown, the AR HMD 200 may communicate directly or indirectly with other devices and/or user devices via one or more communication paths and/or communication networks including short-range, point-to-point communication paths, such as USB cables, IEEE 1394 cables, wireless paths (e.g., Bluetooth, infrared, IEEE 802-11x, etc.), or other short-range communication via wired or wireless paths. For example, the I/O circuitry 212 may include a Bluetooth network adaptor.

The power source 216 may include a source of power or an interface for coupling to an external power source. The power source 216 may be coupled to other components of the AR HMD 200. Some non-limiting examples of a power source 216 include a battery, solar generator, and/or a wired power source.

The microphone 218 and the speaker 220 may be included as integrated equipment with other elements of the AR HMD 200. In some embodiments, the microphone 218 and the speaker 220 may be external to the AR HMD 200 as stand-alone units. An audio component of videos and other overlay display content may be played through the speaker 220 (or external headphones or other external audio device). The microphone 218 may receive audio input such as voice commands or speech. For example, a user may speak voice commands that are received by the microphone 218 and recognized by control circuitry 206.

The camera 222 may be any suitable type of image sensor, camera, or other form of image sensor operating in the visual spectrum that is configured to capture successive images as a video. In some embodiments, the image sensor is integrated with the AR HMD 200. In some embodiments, the image sensor may be external and communicably connected to the AR head-mounted display. In some embodiments, the image sensor may be a digital camera that includes a charge-coupled device (CCD) and/or a complementary metal-oxide semiconductor (CMOS) image sensor. In some embodiments, the image sensor may be an analog camera that converts still analog images to digital images via the control circuitry 206 or via a video card.

In some embodiments, the AR HMD 200 may be communicatively coupled to one or more user input interfaces or devices. Some examples of input devices include a remote control, a secondary user device, a touch-sensitive display, a smartphone device, a tablet, a remote control, mouse, trackball, keypad, keyboard, touchscreen, touchpad, stylus input, joystick, voice recognition interface, and/or other user input interfaces. In some embodiments, the AR HMD 200 may include an integrated eye-tracking system or other image sensors directed at the user's eyes to enable determining the dominant eye of the user. In some embodiments, the AR HMD 200 may include one or more user interfaces (e.g., buttons, touch-sensitive bars, etc.) for a user to manually provide input to the AR HMD 200.

FIG. 3 is a flowchart illustrating the steps of an exemplary process 300 for selectively displaying overlays in an AR environment. Process 300 may be implemented on the user devices discussed herein and other systems that may display an AR environment to a user. One or more actions of process 300 may be incorporated into or combined with one or more actions of any other process or embodiment described herein. For purposes of clarity, this process 300 is described in the context of being implemented on the AR HMD 200 shown in FIG. 2. Also, the AR HMD 200 may perform the actions of process 300 as part of any software being executed by the control circuitry of the AR HMD 200. For example, one or more steps of the process may be executed as part of the operating system of the AR HMD and/or as part of the overlay selection application and/or as part of any other systems, applications, functions, and/or subroutines executed by the control circuitry.

At step 302, the control circuitry determines if there is a new image frame available for analysis. The image frame is captured from video input of the scene within the field of vision of the image sensor and the wearer of the AR HMD. In some embodiments, the video input may be generated with multiple frames per second (e.g., 8 fps, 16 fps, 24 fps, 30 fps, or other frame rates), and the control circuitry may capture for analysis fewer than all the frames generated in the video per second. For example, the control circuitry may capture for analysis one frame per second, or the control circuitry may capture for analysis multiple frames per second. In some embodiments, the control circuitry may capture for analysis fewer than one frame per second, e.g., one frame every two seconds or more. Embodiments that capture fewer frames per second may be used to preserve battery life of the AR HMD when the wearer of the AR HMD is stationary or moving slowly (e.g., walking, hiking, in a slow-moving vehicle, and the like). In some embodiments with global positioning capabilities, the control circuitry may estimate the speed of the AR HMD wearer and adjust the rate of image frame analysis accordingly.

At step 304, the control circuitry performs object detection though analysis of the captured image frame. The object detection analysis identifies one or more digitized objects within the captured image of the scene. Each digitized object is represented by groups of pixels, and each digitized object may represent anything physically present within the scene in the field of view of the image sensor. At step 306, the control circuitry identifies candidate overlays, and each candidate overlay is associated with one of the digitized objects. At step 308, the control circuitry determines relevancy values for each digitized object associated with a candidate overlay and determines a weight factor for each relevancy value. In some embodiments, the relevancy values may include a likelihood of attention (L_{A}), a likelihood of viewing (L_{V}), and a likelihood of interest (L_{I}). For purposes of clarity, the description herein may refer to these three specific relevancy values by way of example, and such reference is intended to be non-limiting. In some embodiments, other relevancy values may be used in addition to or instead of the aforementioned relevancy values. In some embodiments, each weight factor is a number in the range of 0 to 1 and is used for exponentially weighting the associated of the relevancy values. At step 310, the control circuitry calculates a combined metric by mathematically aggregating the weighted relevancy values. In an embodiment using the L_{A}, L_{V}, and L_{I} relevancy values associated with each digitized object, the combined metric, Cᵢ, for each digitized object may be calculated using the following equation:

$${c}_{i} = {( {L}_{A} )}^{a} \cdot {( {L}_{V} )}^{b} \cdot {( {L}_{1} )}^{c} ,$$

where a, b, and c are weight factors and i represents identifier for a digitized object. The combined metric is a measurement of the overall relevance of a digitized object to the wearer of the AR HMD.

The weight factors, a, b, and c, are used to provide a weight to each of the likelihood of attention (L_{A}), the likelihood of viewing (L_{V}), and the likelihood of interest (L_{I}) relevancy values, respectively, when calculating the combined metric Cᵢ for a digitized object. Any one of the weight factors may be set to a value of zero to discard the associated relevancy value from the combined metric calculation. The value of each weight factor may be dependent on the wearer of the AR HMD. In some embodiments, the weight factors may be set at an initial non-zero value and then adjusted as the wearer uses the AR HMD, with the AR HMD automatically adjusting one or more of the weight factors based on the wearer's interactions with selected candidate overlays and/or the wearer's interest shown in digitized objects that are semantically linked to particular topics. In such embodiments, the AR HMD may adjust the weight factors based on the wearer's habits and interests established while wearing the AR HMD. In some embodiments, the wearer may be prompted by the AR HMD to identify categories of personal interest, with the weight factor of the likelihood of interest being set to a higher value if the digitized object is identified as being within one the wearer's categories of interest and set to a lower value otherwise.

The likelihood of attention (L_{A}) relevancy value is a measure of the salience of the digitized object in the captured image from the video input provided by the image sensor. In some embodiments, the saliency may also be based on motion within the video. sound included in the video, and/or other factors that may be included as metadata for the digitized object. The visual salience measured from the captured image is a determination that a digitized object, which represents a real-world part of the scene, is sufficiently different from other parts of the scene to be worthy of attention. This measure of salience does not provide the AR HMD with an understanding of what the digitized object is, but rather only that the digitized object stands out within the scene. The reasons why a digitized object may stand out from other parts of the scene include the color, the brightness, the shape, the location amongst other parts of the scene, the inclusion of text, patterns, and the like. For example, a sign may stand out based on the color, the shape, and the inclusion of text and/or artwork. A tree may stand out in a cityscape. Cars may stand out because they have the road as a background. A building may stand out because it is taller than surrounding buildings or because of the architecture. There are many reasons why one group of pixels may stand out from other surrounding pixels within a captured image from a scene, and a saliency model may be incorporated into the AR HMD to evaluate how much a group of pixels stands out from the rest of the scene. The likelihood of attention (L_{A}) relevancy value may be assigned as a number between 0 and 1 based on how much the group of pixels stand out from the surroundings within the scene. In the example of the sign, the colors of the sign may be different from the colors around the sign, such that the pixels representing the sign stand out from the surrounding pixels. In some embodiments, the likelihood of attention (L_{A}) relevancy value may be determined from a feature or a combination of features of the pixels themselves, such as the number of pixels, the configuration of the pixels, the color distribution of the pixels, the range of brightness values for the pixels, the focus of the pixels, and the like. In some embodiments, the likelihood of attention (L_{A}) relevancy value may be calculated using a mean, median, or other appropriate centrality measure derived from each pixel of the group of pixels. In some embodiments, the likelihood of attention (L_{A}) relevancy value may be calculated using a probability density function derived from the pixels.

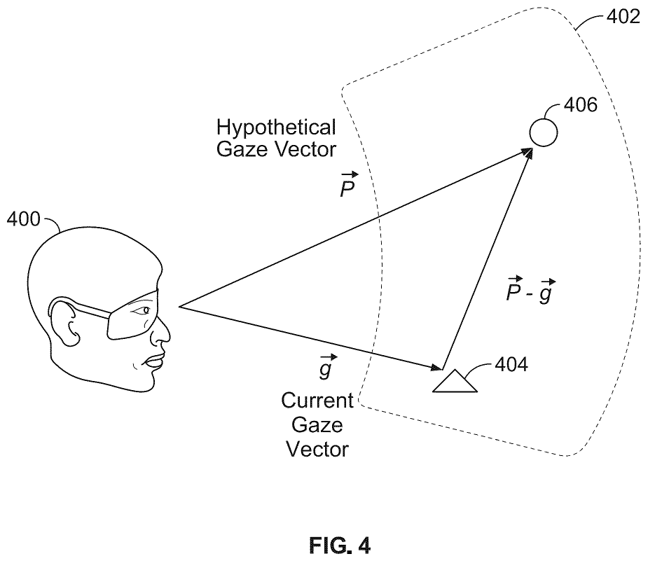

The likelihood of viewing (L_{V}) relevancy value may be determined based on the AR HMD wearer's current head pose and gaze with respect to the location of the digitized object. The AR HMD may determine the wearer's head pose using integrated spatial sensors and tracking the wearer's head movements while wearing the AR HMD. The AR HMD may determine the direction of the wearer's gaze using an integrated eye-tracking system or other optical sensors directed at the user's eyes to enable eye-tracking. Referring to FIG. 4, the scene within the field of view of the wearer 400 AR HMD may be modeled as a spherical 3D envelope 402, such that a gaze vector, \vec{g}, representing the direction and depth of the wearer's current gaze, defines a gaze point 404 within the spherical 3D envelope 402. Similarly, an object 406 within the scene may be represented by a hypothetical gaze vector, \vec{P}. The likelihood of the wearer 400 viewing the object 406 decreases with the distance of the object 406 from the gaze point 404. In particular, the likelihood of the wearer 400 to view the object 406 within the scene is inversely proportional difference between the gaze vector, \vec{g}, and the hypothetical gaze vector, \vec{P}. The likelihood of viewing (L_{V}) relevancy value may therefore be determined as follows:

$${L}_{V} ( \vec{P} ) ∝ \frac{1}{{\vert ( \vec{P} - \vec{g} ) \vert}^{β}} ,$$

where β is a scalar value used to control decay in the likelihood of viewing (L_{V}) relevancy value as the AR HMD wearer's gaze moves away from the current focus point. Following the vector difference calculation indicated above, the likelihood of viewing (L_{V}) relevancy value may be normalized to a value between 0 and 1.

The scalar β may be set to a default value initially and then adjusted by the AR HMD based on the AR HMD wearer's viewing history. For example, the scalar β value may be set at or near unity for wearers who tend to have significant amounts of head and/or eye movements, as such users may be more likely to view objects that are further away from their current gaze point. As another example, the scalar β value may be set closer to 0.5 or near zero for wearers who tend to have little head and eye movement, which makes such wearers less likely to view objects that are further away from the gaze point. In some embodiments, the scalar β value may be changed based on the type of activity being performed by the AR HMD wearer. For example, while walking the scalar β value may be set between 0.5 and 1 to account for greater head and/or eye movement, and while driving the scalar β value may be set between 0 and 0.5 to account for less head and/or eye movement.

In some embodiments, the gaze vector, \vec{g}, may be determined using the AR HMD wearer's prior head pose/movements and gaze history when performing regular activities, such as walking along or driving on a city street. In some embodiments, gaze vector, \vec{g}, may be determined from an average of the AR HMD wearer's recent head and eye movement.

In some embodiments, depth of objects in the scene may not be resolvable. In such embodiments, an estimate may be used for the depth based on a focus determination for the object, or alternatively, depths of both the gaze vector and the hypothetical gaze vector may be set at unity for purposes of calculating the likelihood of viewing (L_{V}) relevancy value.

The likelihood of interest (L_{I}) relevancy value may be determined based on prior configuration information provided by the AR HMD wearer (e.g., answering questions to identify personal interests) and/or by the AR HMD learning the AR HMD wearer's preferences over time based on gaze data. The likelihood of interest (L_{I}) relevancy value represents the AR HMD wearer's interest in digitized objects following semantic interpretation of a captured image and/or a group of pixels to identify a digitized object and the object in the scene that the digitized object represents. The semantic interpretation of the captured image or group of pixels may be performed by the AR HMD. In some embodiments, the semantic interpretation may be performed remotely by servers, services, and/or other computing platforms (e.g., such as the AR HMD wearer's smartphone or other personal device in communication with the AR HMD). Similar to the other relevancy values, the likelihood of interest (L_{I}) relevancy value may be represented by a value between 0 and 1. In some embodiments, a temporal aging algorithm may be used to determine the likelihood of interest (L_{I}) relevancy value for a digitized object related to a particular topic of interest. For example, if at a time t₀, the AR HMD wearer states an interest in a particular topic, then at that time t₀ the likelihood of interest (L_{I}) relevancy value may be 1. At a later time, t, where t>t₀, the temporal aging algorithm for the likelihood of interest (L_{I}) relevancy value for a digitized object related to a particular topic of interest, may be determined by:

$${L}_{i} ( Topic , t ) = \frac{1}{{( t - {t}_{0} )}^{γ}} ,$$

in which γ is a scalar aging parameter between 0 to 1 that is used to control the rate of temporal aging. The aging parameter, γ, may also depend on the particular topic of interest based on the AR HMD wearer's stated interests or history of interests. By basing the aging parameter, γ, on the AR HMD wearer's interest in the particular topic, the likelihood of interest (L_{I}) relevancy value may be tailored to represent whether the topic is of transient interest to the AR HMD wearer or whether the topic is of more persistent interest to the AR HMD wearer. In some embodiments, each time the AR HMD wearer shows an active interest in a particular topic, t₀ and t may be reset so that the aging for likelihood of interest (L_{I}) relevancy value is similarly reset.

In some embodiments, the AR HMD wearer's interest in a topic may be determined using direct feedback such as mentioning the topic while speaking, mentioning a closely related topic, opening an application on a personal device (which shares information with the AR HMD) that relates to the topic, checking a box related to the topic on a questionnaire, the like. In some embodiments, the AR HMD wearer's interest in a topic may be determined using indirect feedback such as the AR HMD wearer gazing at an image or object related to the topic for greater than a threshold period of time, interacting with multimedia or an object related to the topic, and the like. For example, the AR HMD wearer may peruse cars of various makes and models on one or more personal devices (including, but not limited to, the AR HMD), or the AR HMD wearer may gaze at a car using an application operating on the AR HMD or other personal device, or the AR HMD wearer may engage in conversations with friends about cars of certain makes and models. Any one or more of these cues may be used to push the aging parameter, Y, towards a value of 1, which is a reflection of the AR HMD wearer's interest in cars. By raising the likelihood of interest (L_{I}) relevancy value in the topic of cars, the AR HMD increases the chance of an overlay about cars being displayed to the AR HMD wearer when a car of interest to the AR HMD wearer is serendipitously encountered by the AR HMD wearer.

In some embodiments, the relevancy values and the weight factors associated with the relevancy values may be customized based on the AR HMD wearer's explicit interests, implicit interests, and/or any other basis identified by the AR HMD wearer or on the AR HMD wearer's behalf. For example, the AR HMD wearer may be traveling to a different city for work, and because the travel is work-related, the relevancy values and/or the weight factors may be determined differently, as compared to when the AR HMD wearer is in their home city, to emphasize work-related information and/or interests.

Returning to process 300 of FIG. 3, at step 312, the control circuitry generates a metric ranking of the plurality of digitized objects based on the calculated combined metrics. In some embodiments, it may be advantageous to sort this this metric ranking from greatest combined metric to least, which leaves the most relevant digitized objects at the top of the metric ranking and facilitates identifying the highest ranked combined metrics. At step 314, the control circuitry determines the number and spacing of overlays currently displayed on the overlay display. At step 316, the control circuitry determines if there is room for displaying additional overlays on the overlay display. In some embodiments, a threshold may be set for the maximum number of overlays displayed, and if the number of displayed overlays equals or exceeds the threshold, then at step 316 the control circuitry determines that no more overlays may be displayed. If no more overlays may be displayed, process 300 returns to step 302 to capture an image frame. If there is space for additional overlays, then at step 318, the control circuitry selects the candidate overlays of the top ranked digitized objects for display on the overlay display, and at step 320, the control circuitry displays the selected candidate overlays on the overlay display of the AR HMD. After displaying the selected candidate overlays, process 300 returns to step 302 to capture an image frame.

In some embodiments, a candidate overlay may create a viewing conflict with an active displayed overlay due to the preferred display location on the overlay display. In such instances, control circuitry may determine that the candidate overlay with the conflict should not be displayed, and the candidate overlay associated with the digitized object having the next highest combined metric may be selected for display instead.

In some embodiments, a threshold area may be set for the total visual area occupied by overlays displayed on the overlay display at one time. In such embodiments, the control circuitry may determine the total visual area occupied by displayed overlays, compare the total visual area occupied to the threshold area, and from that comparison determine whether additional candidate overlays may be added to the overlay display. In such embodiments, at step 318 the control circuitry may select the candidate overlays of the top ranked digitized objects and determine the total visual area that would be occupied with the selected candidate overlays added to the overlay display with the active overlays. If the determined total visual area would be less than the threshold area, then the selected candidate overlays may be displayed on the overlay display. However, such embodiments may result in a candidate overlay associated with a digitized object having a high rank in the metric ranking being passed over because the visual area required to display the candidate overlay would increase the total visual area occupied above the threshold area. In such instances, the candidate associated with the digitized object having the next highest combined metric may be selected for display instead.

In some embodiments, a threshold number of overlays may be set for overlays displayed on the overlay display at one time. For example, if the threshold number of overlays is five overlays, and two overlays are currently being displayed on the overlay display, then up to three candidate overlays may be selected for display. In some embodiments, the scene complexity may be used to set the upper threshold number of overlays for display. In such embodiments, the complexity of the currently displayed overlays may be considered in conjunction with the complexity of the scene to determine the overall visual complexity presented to the wearer. Complexity, in such embodiments, may be based on the number of distinct digitized objects within the AR HMD wearer's field of view. In some embodiments, the complexity of the entirety of a scene may be evaluated by analyzing the range of colors, the range of brightness, and the like. Also, in such embodiments, the complexity of a candidate overlay may be evaluated prior to display to ensure that the overall visual complexity presented to the AR HMD wearer does not exceed the threshold once the candidate overlay is added to the overlay display.

In some embodiments, the AR display may be divided into zones (e.g., a central visual zone and one or more peripheral visual zones) and a threshold number of overlays may be set for displaying overlays in each zone. For example, the central visual zone may be limited to one or two overlays, while each of a left side peripheral zone and a right side peripheral zone may be limited to up to three overlays each. The control circuitry may therefore evaluate each visual zone independently of the other visual zones when determining whether sufficient space exists to display candidate overlays.

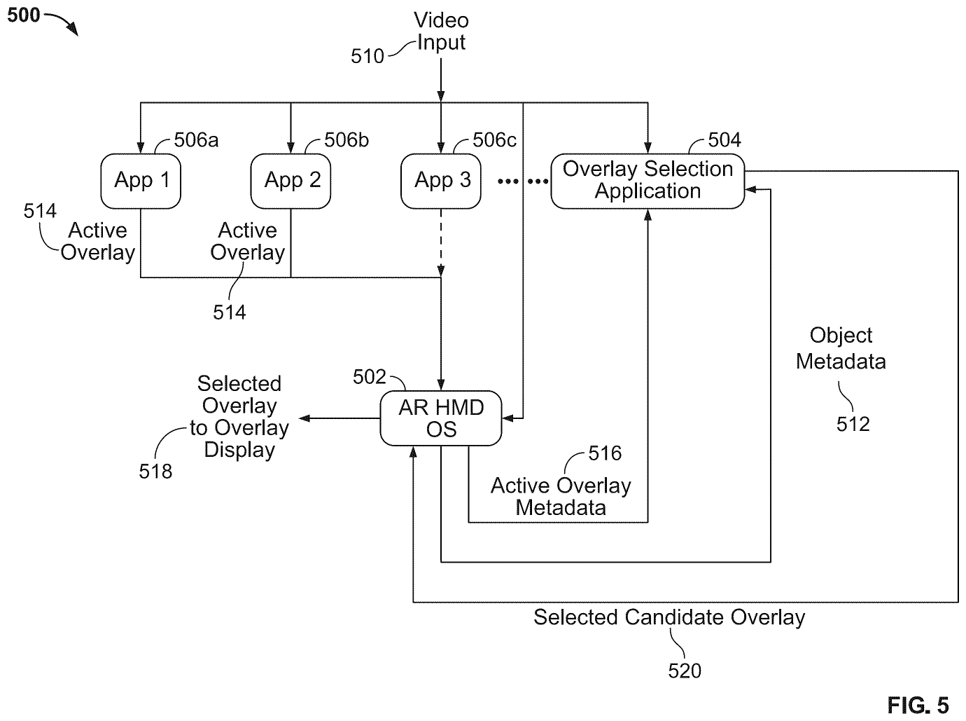

FIG. 5 schematically illustrates a system architecture 500 that may be used to implement a process for selectively displaying overlays in an augmented reality environment. The system architecture 500 shows the approximate stages of the architecture which may be used to implement process 300 of FIG. 3. The system architecture 500 includes the AR HMD OS 502, the overlay selection application 504, and active user applications 506a-c. In some embodiments, the system architecture 500 may include software components in addition to those shown in FIG. 5. Communications between components of the system architecture 500 may be achieved using any functional programmatic technique implemented through software, using hardware, or combinations thereof. For example, communications between components may be achieved by a first component writing data to a memory space that may be accessed and read by a second component. As another example, communications between components may be achieved by the AR HMD OS 502 acting as an intermediary to pass data from a first component to a second component. In yet another example, a first component and a second component may be configured to communicate directly with each other. In embodiments in which components of the system architecture 500 reside on and/or are executed in different physical spaces (e.g., distinct hardware components), communications between components may be achieved via one or more hardware connections (e.g., traces, wired connections, wireless communications connections, networks, and the like).

The system architecture 500 receives video input 510 from the image sensor of the scene within the field of view of the image sensor. The video input 510 is communicated to the AR HMD OS 502, to the overlay selection application 504, and as needed to the active user applications 506a-c. The AR HMD OS 502 captures at least one image frame from the video input 510 and performs the object detection analysis on a captured image frame to generate the object metadata 512. As part of the object detection analysis, in addition to analyzing the captured image frame, the AR HMD OS 106 may monitor the video input to facilitate identifying digitized objects represented in the scene. The digitized objects are represented by groups of pixels, and each digitized object may represent anything physically present within the field of view of the image sensor. For example, in a scene of a city street, a digitized object may be a street sign, a car that is parked or driving on the street, a business sign, a place of business, a bus stop, a tree, a shrub, flowers, a landmark, and anything else within the field of view of the image sensor.

In some embodiments, the overlay selection application 504 may perform the object detection analysis instead of the AR HMD OS 502. In such embodiments, this may alleviate any synchronization issues between the AR HMD OS 502 and the overlay selection application 504 when these components perform different parts of the overlay selection process (see FIG. 3) based on the same video input 510. In some embodiments, the overlay selection application 504 may be entirely incorporated into the AR HMD OS 502, which would also alleviate any synchronization issues. In such embodiments, the AR HMD OS 502 may perform the entire overlay selection and display process without the wearer needing to actively invoke the overlay selection application 504 as a separate application.

The object metadata 512 may include information relating to the digitized object. Each digitized object is a collection of pixels, such that the object metadata 512 may include information about the pixels, including information such as the optical focus of the digitized object (which may aid in identifying digitized objects beyond the depth of field of the image sensor), the number of pixels, the configuration of the pixels, the color distribution of the pixels, the range of brightness values for the pixels, and the like. The object metadata 512 may also include object recognition information associated with the digitized object, such as object identification information, geolocation information, time of day information, position within the video or captured image frame, location of network-accessible information, and the like.

Each of the active user applications 506a-c may process the video input for any required purpose the active user applications 506a-c may have. In the system architecture 500 as shown, each active user applications 506a-b is configured by the AR HMD wearer to display an active overlay 514 on the overlay display. The wearer may reconfigure active user applications 506a-b so that one or both is configured to not display an active overlay on the overlay display. As shown, the active user application 506c is configured by the AR HMD wearer to not display an active overlay on the overlay display. However, the AR HMD wearer may choose to change the configuration of the active user application 506c so that the active user application 506c displays an active overlay on the overlay display. Since the active overlays 514 generated by the active user applications 506a-b are explicitly selected by the AR HMD wearer, display of the active overlays 514 takes priority over candidate overlays that are selected for display by the overlay selection application 504.

To display the active overlays 514 on the overlay display, each of the active user applications 506a-b communicates display parameters and active overlay metadata 516 for each respective active overlay 514 to the AR HMD OS 502. The display parameters for each active overlay 514 provide the AR HMD OS 502 with detailed information related to displaying each active overlay 514 on the overlay display. The display parameters may include text and graphics to be displayed as part of each active overlay 514, font type and font size for each active overlay 514, and a color palette for each active overlay 514. The display parameters may include additional data for use by the AR HMD OS 502 to display each active overlay 514 on the overlay display. The active overlay metadata 516 may include additional information related to each active overlay 514, including, for example, an overlay identifier, an application identifier to identify the active user application 506a-b generating each respective active overlay 514, the preferred display location for each active overlay 514 on the overlay display, the preferred display size of each active overlay 514, and other data associated with the display of each active overlay 514. The AR HMD OS 502 may use the display parameters and the active overlay metadata 516 associated with each active overlay 514 to generate the respective active overlay 514 for display on the overlay display. The AR HMD OS 502 may make additions and/or changes to the active overlay metadata 516 associated with an active overlay 514 based on the generation and display of the active overlay 514. For example, in some embodiments, the actual display location of an active overlay 514 on the overlay display and/or the actual display size of an active overlay 514 may be added to the active overlay metadata 518.

The AR HMD OS 502 communicates the active overlay metadata 516, including any additions and/or changes, to the overlay selection application 504. The AR HMD OS 502 also communicates object metadata 512 associated with digitized objects to the overlay selection application 504. The overlay selection application 504 processes the object metadata 512, in conjunction with the video input 510, to identify candidate overlays 520, determine relevancy values for the digitized objects identified in the video input 510 by the AR HMD OS 502, generate a metric ranking, based on the relevancy values, for the identified candidate overlays, and select one or more of the candidate overlays for display on the overlay display. Details of processes performed by the overlay selection application 504 are described above in FIG. 3.

Following the candidate overlay selection process, the overlay selection application 504 communicates selected candidate overlays 520, along with the associated candidate overlay metadata for each selected candidate overlay 520, to the AR HMD OS 502. The candidate overlay metadata for each selected candidate overlay 520 provides the AR HMD OS 502 with detailed information, including display parameters, related to selected candidate overlays 520 on the overlay display. The candidate overlay metadata may include text and graphics to be displayed as part of each selected candidate overlay 520, font type and font size for each selected candidate overlay 520, and a color palette for each selected candidate overlay 520. The candidate overlay metadata may include additional data for use by the AR HMD OS 502 to display each selected candidate overlay 520 on the overlay display. The candidate overlay metadata may also include additional information related to each selected candidate overlay 520, including, for example, some or all data included in the object metadata 512 associated with the digitized object corresponding to each selected candidate overlay 520, the preferred display location for the selected candidate overlay 520 on the overlay display, the preferred display size of the selected candidate overlay 520, and other data associated with the display of the selected candidate overlay 520. The AR HMD OS 502 may use the respective display parameters from the candidate overlay metadata to generate each selected candidate overlay 520 for display on the overlay display. Once the candidate overlay 520 is generated, the AR HMD OS 502 may display the candidate overlay 520 alongside any active overlays already being displayed on the overlay display. The AR HMD OS 502 may make additions and/or changes to the candidate overlay metadata associated with a selected candidate overlay 520 based on the generation and display of the selected candidate overlay 520. For example, in some embodiments, the actual display location of a selected candidate overlay 520 on the overlay display and/or the actual display size of a selected candidate overlay 520 may be added to the candidate overlay metadata.

In some embodiments, candidate overlays displayed on the overlay display may be monitored to determine when display of a candidate overlay should be terminated. This evaluation may be performed, in some embodiments, by implementation of a time decay value in combination with the already calculated metric ranking for each digitized object associated with a displayed candidate overlay. The time decay value may be based on several different factors, such as the length of time the displayed candidate overlay has been displayed, the amount of time the wearer's eye gaze indicates interaction with the displayed candidate overlay, the nature or topic of the displayed candidate overlay, and the like. The time decay value may be determined by a time decay function, D(t), where/is the time since the candidate overlay was first displayed. Since this is intended to be a decay function, the value of D(t) will decrease for greater values of 1. In some embodiments, the time decay function may be expressed in the following basic form:

$$D ( t ) = {e}^{- λ t} ,$$

where λ is a decay rate constant.

In some embodiments, it may be desirable for the time decay function to be adaptive. An adaptive time decay function may take into account, for example, interaction of the AR HMD wearer with the displayed candidate overlay (e.g., based on eye gaze). Such a time decay function may be expressed as:

$$D ( t ) = {e}^{- λ ( 1 + α g ( t ) ) t} ,$$

where λ is the decay rate constant, α is a constant that controls the acceleration of decay based on how many times the AR HMD wearer's gaze has fixed on the displayed candidate overlay, and g(t) is a time-based function, which returns a whole number, representing how many times the wearer's gaze has fixed on the displayed candidate overlay. From this adaptive version of a time decay function, the more the AR HMD wearer gazes at the displayed candidate overlay, the longer the displayed candidate overlay will persist on the overlay display.

In some embodiments, it may be desirable to have to the time decay function take into account whether or not the displayed candidate overlay should be more or less persistent apart from how many times the AR HMD wearer has gazed at the displayed candidate overlay. Such a time decay function may be expressed as:

$$D ( t ) = {e}^{- β λ ( 1 + α g ( t ) ) t} ,$$

where λ is the decay rate constant, α is a constant that controls the acceleration of decay based on how many times the wearer's gaze has fixed on the displayed candidate overlay, g(t) is a time-based function, which returns a whole number, representing how many times the AR HMD wearer's gaze has fixed on the displayed candidate overlay, and β is a type-specific constant that modifies the decay rate. The β constant may be set to 0 for persistent candidate overlays and to 1 for non-persistent candidate overlays.

Any one of the above time decay functions may be incorporated into the combined metric calculation, expressed by the following as a function of time:

$${C}_{i} ( t ) = {( {L}_{A , i} )}^{a} \cdot {( {L}_{V , i} )}^{b} \cdot {( {L}_{I , i} )}^{c} \cdot {D}_{i} ( t ) ,$$

where i refers to the i-th displayed candidate overlay. This combined metric may be calculated for displayed candidate overlays to determine when the displayed candidate overlay should no longer be displayed. In some embodiments, terminating display of a displayed candidate overlay may occur when the calculated combined metric Cᵢ(t) for the displayed candidate overlay falls below a predetermined threshold. In some embodiments, terminating display of a displayed candidate overlay may occur when the calculated combined metric Cᵢ(t) for the displayed candidate overlay falls below a predetermined number of the top ranked candidate overlays (e.g., the top two, three, or five) being considered for display based on the combined metric calculated for candidate overlays under consideration.

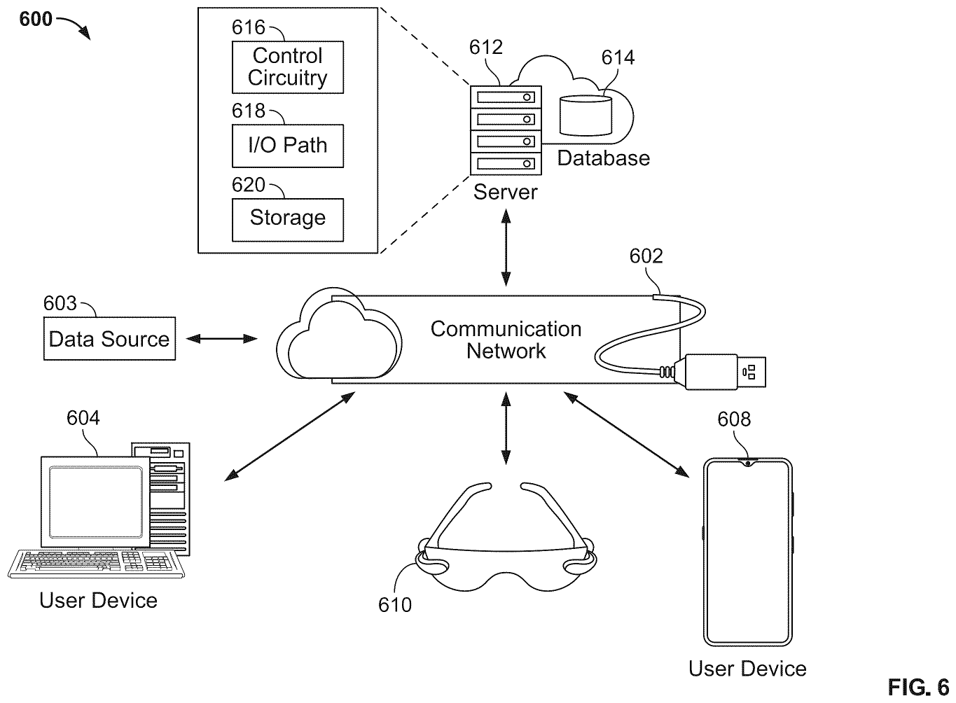

FIG. 6 is an example of an illustrative system 600 implementing the user device, in accordance with embodiments of the disclosure. The user devices 604, 608, 610 (respectively, a computer, a smartphone, and AR glasses) may be coupled to communication network 602. The user devices 604, 608, 610 may include control circuitry, storage, and I/O circuitry similar to, e.g., control circuitry 206, storage 210, and I/O circuitry 212 from FIG. 2. Communication network 602 may be one or more networks including the internet, a mobile phone network, mobile voice or data network (e.g., a 4G, 5G or LTE network), or other types of communication networks or combinations of communications networks.

System 600 may comprise data source 603, one or more servers 612, and/or one or more edge computing devices. In some embodiments, the application may be executed at one or more of control circuitry 616 of server 612 (and/or control circuitry of user devices 604, 608, 610 and/or control circuitry of one or more edge computing devices). Communications with the data source 603, which may also be a media content source, and the user devices may be exchanged over one or more communication paths. In some embodiments, the user devices exchange communications with the other user devices over one or more communication paths. In some embodiments, the data source 603 and/or server 612 may be configured to host or otherwise facilitate communication sessions between user devices 604, 608, 610 and/or any other suitable user devices, and/or host or otherwise be in communication (e.g., over communication network 602) with one or more network services.

In some embodiments, server 612 may include control circuitry 616 and storage 620 (e.g., RAM, ROM, Hard Disk, Removable Disk, etc.). Storage 620 may store one or more databases. Server 612 may also include an I/O path 618. In some embodiments, I/O path 618 is an I/O circuitry. I/O circuitry may be, e.g., a NIC card, audio output device, mouse, keyboard card, any other suitable I/O circuitry device or combination thereof. I/O path 618 may provide device information, or other data, over a local area network (LAN) or wide area network (WAN), and/or other content and data to control circuitry 616, which may include processing circuitry, and storage 620. Control circuitry 616 may be used to send and receive commands, requests, and other suitable data using I/O path 618, which may comprise I/O circuitry. I/O path 618 may connect control circuitry 616 to one or more communications paths.

Control circuitry 616 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 616 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 616 executes instructions for an emulation system application stored in memory (e.g., the storage 620). Memory may be an electronic storage device provided as storage 620 that is part of control circuitry 616. Memory may store instruction to run the application.

Data source 603 may include one or more types of content distribution equipment including a media distribution facility, satellite distribution facility, programming sources, intermediate distribution facilities and/or servers, internet providers, on-demand media servers, and other content providers. In some embodiments, the user devices access the data source 603 to receive data associated with overlay displays. In some approaches, data source 603 may be any suitable server configured to provide any information needed for operation of the user devices as described above and below (e.g., in FIGS. 1-5). For example, data source 603 may provide overlay display data, metadata associated with overlay displays, applications for executing functions and operation of user devices, and/or any other suitable data needed for operations of user devices (e.g., as described in FIGS. 1-5).

Although communications paths are not drawn between user devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user devices may also communicate with each other directly through an indirect path via communication network 602.

Processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based on at least in part on a prior step.

1. A method of selectively displaying overlays in an augmented reality environment, the method comprising:
monitoring, using control circuitry and a head-mounted display comprising an image sensor and an overlay display, a scene within a field of view of the image sensor to identify a plurality of digitized objects by performing image analysis on captured images of the scene;
identifying, using the control circuitry, a plurality of candidate overlays, each candidate overlay associated with one of the plurality of digitized objects;
determining, using the control circuitry, a plurality of relevancy values for each digitized object and a weight factor for each relevancy value;
calculating, using the control circuitry, a combined metric for each digitized object based on the determined relevancy values and the determined weight factors associated with each respective digitized object;
generating, using the control circuitry, a metric ranking of the digitized objects based on the calculated combined metric for each digitized object;
selecting, using the control circuitry, one or more of the candidate overlays for display on the overlay display based on a rank of the respective digitized objects within the metric ranking; and
displaying, on the overlay display, the selected candidate overlays.

2. The method of claim 1, further comprising:
determining, using the control circuitry, a display size of each candidate overlay;
determining, using the control circuitry, available space on the overlay display for displaying the candidate overlays; and
selecting, using the control circuitry, the one or more of the candidate overlays for display on the overlay display based on the rank of the respective digitized objects within the metric ranking, the display size of the candidate overlays, and the determined available space.

3. The method of claim 1, wherein determining the plurality of relevancy values for each digitized object comprises determining, using the control circuitry, at least one of a likelihood of attention value, a likelihood of viewing value, or a likelihood of interest value for each digitized object.

4. The method of claim 3, wherein determining the likelihood of attention value for each digitized object comprises determining, using the control circuitry, an object salience value for each digitized object.

5. The method of claim 4, further comprising calculating for each digitized object, using the control circuitry, the object salience value from a plurality of pixel salience values for pixels included as part of each digitized object.

6. The method of claim 4, further comprising determining for each digitized object, using the control circuitry, a probability density function associated with pixels included as part of each digitized object.

7. The method of claim 3, wherein determining the likelihood of viewing value for each digitized object comprises determining, using the control circuitry and a viewing vector function, a viewing vector function value for each digitized object.

8. The method of claim 7, further comprising determining for each digitized object, using the control circuitry, the viewing vector function value based on a comparison between a first gaze vector, which is based on an actual gaze of a wearer of the head-mounted display, and a second gaze vector, which is based on a hypothetical gaze of the wearer when gazing at the digitized object within the monitored scene.

9. The method of claim 7, further comprising determining for each digitized object, using the control circuitry, a viewing decay value for use in the viewing vector function.

10. The method of claim 3, wherein determining the likelihood of interest value for each digitized object comprises determining, using the control circuitry and an interest decay function, an interest decay function value for each digitized object.

11. The method of claim 10, further comprising determining for each digitized object, using the control circuitry, a decay value for use in the interest decay function, the decay value based on prior determined interests of a wearer of the head-mounted display.

12. The method of claim 10, further comprising determining for each digitized object, using the control circuitry, a decay value for use in the interest decay function, the decay value based on implicit interests of a wearer of the head-mounted display.

13. The method of claim 10, further comprising determining for each digitized object, using the control circuitry, a decay value for use in the interest decay function, the decay value based on explicit interests of a wearer of the head-mounted display.

14. The method of claim 1, further comprising calculating, using the control circuitry, a display metric from a display decay function for each of the displayed candidate overlays.

15. The method of claim 14, further comprising determining the display decay function based on the determined relevancy values associated with each respective displayed candidate overlay and on a time decay function.

16. The method of claim 14, further comprising removing one or more of the displayed candidate overlays from the overlay display in response to the display metric falling below a predetermined decay threshold.

17. A system for selectively displaying overlays in an augmented reality environment comprising:
an image sensor;
an overlay display; and
control circuitry configured to:
monitor a scene within a field of view of the image sensor to identify a plurality of digitized objects by performing image analysis on captured images of the scene;
identify a plurality of candidate overlays, each candidate overlay associated with one of the plurality of digitized objects;
determine a plurality of relevancy values for each digitized object and a weight factor for each relevancy value;
calculate a combined metric for each digitized object based on the determined relevancy values and the determined weight factors associated with each respective digitized object;
generate a metric ranking of the digitized objects based on the calculated combined metric for each digitized object;
select one or more of the candidate overlays for display on the overlay display based on a rank of the respective digitized objects within the metric ranking; and
display, on the overlay display, the selected candidate overlays.

18. The system of claim 17, control circuitry further configured to:
determine a display size of each candidate overlay;
determine available space on the overlay display for displaying the candidate overlays; and
select the one or more of the candidate overlays for display on the overlay display based on the rank of the respective digitized objects within the metric ranking, the display size of the candidate overlays, and the determined available space.

19. The system of claim 17, wherein the control circuitry is configured to determine the plurality of relevancy values for each digitized object by determining at least one of a likelihood of attention value, a likelihood of viewing value, or a likelihood of interest value for each digitized object.

20. The system of claim 19, wherein the control circuitry is configured to determine the likelihood of attention value for each digitized object by determining an object salience value for each digitized object.

21-48. (canceled)
